(19) United States
(12) Patent Application Publication
(10) Pub. No.: US 2009/0188618 A1
(43) Pub. Date: Jul. 30, 2009

(54) LOW VOLATILE ORGANIC COMPOUND COATING

(75) Inventors: JAMES BURKE, Granby, MA (US); NICHOLAS DION, Agawam, MA (US); SUSAN KRAWCZYK, Sunderland, MA (US)

Correspondence Address: MCCORMICK, PAULDING & HUBER LLP, CITY PLACE II, 185 ASYLUM STREET, HARTFORD, CT, 06103, US

(73) Assignee: HAMPDEN PAPERS, INC., HOLYOKE, MA (US)

(21) Appl. No.: 12/020,126

(22) Filed: Jan. 25, 2008

(51) Int. Cl. B32B 38/14; C09D 133/08

(52) U.S. Cl. 156/277; 524/261

(57) ABSTRACT

The invention relates to a water-based coating for lottery applications. The coating is a primer coating that is applied onto a foil layer of a lottery document that allows for the printing of an indicia image for purposes of a lottery game. The coating comprises a composition of an acrylic emulsion polymer such as Joncryl HR 1620, water, a mineral oil defoamer such as BYK-035, a finely micronized polypropylene wax such as Micropro 440W, and an acrylic emulsion binder such as Joncryl 624. The coating has low levels of volatile organic compounds and no known carcinogens. In addition, the coating still meets the specifications of the lottery and gaming industry.

### FIELD OF THE INVENTION

This invention relates in general to a low volatile organic compound coating. More particularly, the invention deals with a water-based, low volatile organic compound coating for lottery tickets that meets the numerous specifications of the lottery and gaming industry while also having no known carcinogens.

### BACKGROUND OF THE INVENTION

Lottery tickets have become an increasingly popular form of legal gambling. One of the more popular lottery ticket games is an instant win ticket, wherein the numbers are concealed on the actual ticket and the buyer must scratch off a coating to reveal them. Once the coating is removed, the ticket buyer can instantly determine whether he or she has won.

Lottery and gaming scratch-off tickets are often produced on an aluminum foil laminated or metallized transfer substrate. For further conversion of the laminated or metal transfer stock, a primer coating is need on the foil/metal transfer to inhibit oxidation of the metals and to provide a printable surface. The printable surface allows for the printing of an indicia image for purposes of the lottery game.

Unfortunately, the manufacturing and production of this primer coating results in the use of high levels of volatile organic compounds and carcinogens. Volatile organic compounds are emitted as gases from certain solids or liquids, such as methyl ethyl ketone. These volatile organic compounds may have both short and long-term health effects. The adverse health effects include eye and respiratory tract irritation, headaches, nausea, memory impairment, and cancer. Clearly, workers engaged in the making of this coating are subject to unsafe health conditions.

With the forgoing problems and concerns in mind, it is the general object of the present invention to provide a low volatile organic compound coating, which overcomes the above-described drawbacks while satisfying the requirements of the lottery and gaming industry such as thickness, tamper-resistance, and adhesion.

### SUMMARY OF THE INVENTION

It is an object of the present invention to provide a low volatile organic compound coating.

It is another object of the present invention to provide a water-based, low volatile organic compound coating for lottery applications.

It is another object of the present invention to provide a water-based, low volatile organic compound coating for lottery applications that satisfies the requirements of the lottery and gaming industry such as thickness, tamper-resistance, and adhesion.

It is another object of the present invention to provide a water-based, low volatile organic compound coating for lottery applications that uses low levels of volatile organic compounds during production.

It is another object of the present invention to provide a water-based, low volatile organic compound coating for lottery applications that use no carcinogens during production.

These and other objectives of the present invention, and their preferred embodiments, shall become clear by consideration of the specification, claims and drawings taken as a whole.

### DETAILED DESCRIPTION OF THE PREFERRED EMBODIMENT

The present invention is directed to a water-based, low volatile organic compound coating for lottery tickets that meets the numerous specifications of the lottery and gaming industry while also having no known carcinogens.

A typical lottery ticket consists of several layers. The base layer is usually cardstock or similar material. A foil layer is adhered to the cardstock by means of a suitable adhesive. A primer coating is then applied onto the foil layer to allow for the printing of an indicia image for purposes of the lottery game. A seal coating is then applied over the image to protect it. A release coating is applied over the seal coating to allow for removal of an opaque coating, which hides the indicia image below it. The present invention provides a primer coating that contains low volatile organic compounds and no carcinogens, which has been heretofore unknown in the art.

The method of making the coating of the present invention involves several steps. In a first step, Joncryl HR 1620 (“J1620”) is mixed in a cowls mixer under strong agitation with water, which acts as a diluent and solvent. J1620 is a commercially available acrylic emulsion polymer that provides very good heat and water resistance. In this case, J1620 also functions as a binder in the composition. J1620 is composed of water in the range of 40-50 weight percent, amine salt of modified acrylic copolymer in the range of 30-40 weight percent, zinc ammonium carbonate in the range of 5-10 weight percent, unreacted ammonium hydroxide in the range of 1-3 weight percent, and polypropylene glycol in the range of 1-3 weight percent. Preferably, the composition includes 3.34 to 4.08 pounds of J1620 per gallon of composition, or about 38-46 weight percent of the composition. More preferably, the composition includes 3.71 pounds of J1620 per gallon of composition, or about 42 weight percent of the composition. Additionally, a preferred embodiment of the composition includes 0.36 to 0.5 liters of water per gallon of composition, or about 9-12.5 weight percent of the composition. More preferably, the composition includes 0.40 liters of water per gallon of composition, or about 10 weight percent of the composition.

In a second step, BYK-035 is mixed with water. BYK-035 is a mineral oil defoamer that is commercially available from BYK-Chemie. BYK-035 is composed of a mixture of paraffin-based mineral oils and hydrophobic components containing silicone. Preferably, the mixture includes 0.02 pounds of BYK-035 per gallon of composition, or about 0.23 weight percent of the composition. Also preferably, the mixture includes an additional 0.02 liters of water per gallon of composition, or about 0.5 weight percent of the composition. The BYK-035 and water is premixed and then added to the mixture of J1620 and water that is still under strong agitation in the cowls mixer.

In a third step, Micropro 440W (“MP440W”) is added slowly to the above mixture in the cowls mixer. MP440W is a finely micronized polypropylene wax, which increases the surface slip while imparting excellent resistance to blocking and abrasion. In addition, MP440W also provides steam and heat resistance. MP440W is composed of a polypropylene hydrocarbon mixture. Preferably, the composition includes 0.40 to 0.48 pounds of MP440W per gallon of composition, or about 4.5-5.5 weight percent of the composition. More preferably, the composition includes 0.44 pounds of MP440W per gallon of composition, or about 5 weight percent of the composition.

In a final step, Joncryl 624 (“J624”) is added slowly to the above mixture in the cowls mixer. J624 is an acrylic emulsion that functions as a binder. In addition, J624 also causes the composition to exhibit a high dyne level, which allows printing on the coating if desired. J624 is composed of ammonia salt of modified styrene acrylic polymers in the range of 40-50 weight percent, water in the range of 40-50 weight percent, and unreacted ammonium hydroxide in the range of 0.1 to 1.0 weight percent. Preferably, the composition includes 3.34 to 4.08 pounds of J624 per gallon of composition, or about 38-46 weight percent of the composition. More preferably, the composition includes 3.71 pounds of J624 per gallon of composition, or about 42 weight percent of the composition. Then, the entire mixture is allowed to mix for at least thirty minutes in the cowls mixer.

Although the optimal composition and a range for each component are described above, it is important that the ratio of J1620 to J624 is 1:1. That is, equal amounts of J1620 and J624 must be used when making the present composition. A chart illustrating a preferred embodiment of the present coating is included below.

TABLE 1

| Ingredient | Weight % in composition |
|---|---|
| J1620 acrylic emulsion polymer | 42 |
| water | 10.5 |
| BYK-035 mineral oil defoamer | 0.23 |
| MP440W finely micronized | 5 |
| polypropylene wax | |
| J624 acrylic emulsion binder | 42 |

Finally, the compositions of the present invention may be applied by any conventional printing technique such as gravure, flexo, screen, offset, and letterpress printing. However, direct gravure is the preferred method. The gravure cylinder may have 140 to 300 lines per inch with a 3BCM to 12BCM cell volume. Preferably, the gravure cylinder has 200 lines per inch and a 3BCM cell volume. The web speed may be 250 feet per minute or more. Preferably, the web speed is 500 feet per minute. For drying, the solution may be dried in one or more ovens at a temperature between 250 and 400° F. Preferably, the solution is dried in two ovens of 250° F.

One important aspect of the present invention is that the coating has low volatile organic compound levels, especially when compared to known coatings. For example, Sovereign Commercial Group, Inc. makes a coating under the trade name Primacoat with a manufacturer code I.D. of 59-088A. According to its Material Safety Data Sheet, 59-088A is listed as having the number of volatile organic compounds per gallon of solids as 1.09, providing a volatile organic compound percentage of about 4.90. Sovereign Commercial Group, Inc. makes another coating that is also sold under the trade name Primacoat with a manufacturer code I.D. of 59-082. According to its Material Safety Data Sheet, 59-082 is listed as having 1.70 volatile organic compounds per gallon of solids, providing a volatile organic compound percentage of about 7.60. In contrast, the present coating has 0.14 volatile organic compounds per gallon of solids, which is a volatile organic compound percentage of only 0.625.

Comparing the same three coatings again, 59-088A has a health rating of 2 under the Hazardous Materials Information System (HMIS) of the National Paint and Coatings Association, which would characterize the coating as a moderate hazard. In addition, 59-088A contains formaldehyde, a potential carcinogen. Similarly, 59-082 also has an HMIS rating of 2. However, the present coating has an HMIS rating of 1, which would characterize the coating as only a slight hazard. Moreover, as another important aspect of the present invention, the coating contains no known carcinogens.

Another regulatory measure for safety is California Proposition 65. Under Proposition 65, California publishes a list of chemicals known to cause cancer, birth defects, or other reproductive harm. Then, companies that use or produce these listed chemicals must notify California residents of their existence. According to their Material Safety Data Sheets, both 59-088A and 59-082 contain listed chemicals. Specifically, 59-082 contains n-methyl-2-pyrol-idone, a chemical known to the State of California to cause birth defects or other reproductive harm. 59-088A contains formaldehyde, a chemical known to the State of California to cause cancer. In stark contrast, the present invention does not have any chemicals listed by the State of California as a result of Proposition 65. Therefore, it is an important aspect of the present invention that the coating contains no chemicals known to cause cancer, birth defects, or other reproductive harm.

In addition to providing a safer coating than known coatings, the present invention must also meet the specifications of the lottery and gaming industry. The tests that determine whether the specifications are met are explained below along with the results obtained by the present invention.

### TESTS

For the tests, a lottery ticket with the present coating having the composition as shown in Table 1 was tested.

### Surface Tension Test

The surface tension of a specimen is tested to determine the printability of the specimen. Using a cotton-tipped applicator, swipes of a series of numbered solutions with gradually increasing surface tensions are applied to an 8½ by 11-inch specimen until a solution is found that wets (rather than beads up) the surface of the specimen for a minimum of two seconds. A dyne level is the highest numbered solution that wets the specimen for two seconds. The present invention has a minimum dyne level of 38, which meets lottery specifications.

### Lacquer Coat Weight Test

The purpose of the lacquer coat weight test is to determine the weight of a dry coating applied per unit area of a given paper. A four square inch coated specimen and a four square inch uncoated specimen is placed in a 100° C. oven for five minutes. Then, the basis weight test method described above is used to determine the weight of the coated and uncoated specimen. Finally, the weight of the uncoated sheet is subtracted from the weight of the coated sheet to determine the coat weight. The present invention has a lacquer coat weight of 0.20 to 1.00 pounds per three thousand square feet, which is within the required lottery specifications of 0.20 to 1.50 pounds per three thousand square feet.

### Acid Copper Sulfate Test

In this test, acidic copper sulfate is used to test the presence of an acrylic coating. First, a super-saturated solution of acidic copper (II) sulfate solution is placed drop-wise onto an 8½ by 11-inch sheet of specimen. The solution is left on the coating for five minutes. At the end of the five minutes, the solution is wiped off the specimen. If an acrylic coating is present, the acidic copper sulfate will not mark the surface of the specimen. The present invention has an acrylic coating, so the copper sulfate did not mark the surface of the specimen. Thus, the present invention passed this test.

### Puddling Vapor Test

The purpose of the puddling vapor test is to determine the acrylic coating's resistance to water vapor. In this test, a beaker of water is heated to boiling. A four-inch square of coated sample is placed over the boiling water for three minutes. After three minutes, the sample is removed and scratched with a coin. The sample passes if the coating cannot be scratched off by the coin after the three-minute exposure to the water vapor. The present invention also passed this test.

As will be appreciated by consideration of the embodiments described above, the present invention provides a water-based coating for lottery applications that is safe to manufacture due to its low volatile organic compounds and no known carcinogens. In addition, the coating still meets the specifications of the lottery and gaming industry.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all equivalent embodiments.

What is claimed is:

1. A water-based, low volatile organic compound coating composition substantially devoid of carcinogens, comprising:
an acrylic emulsion polymer;
water;
a mineral oil defoamer;
a finely micronized polypropylene wax; and
an acrylic emulsion binder.

2. The composition according to claim 1, wherein:
said acrylic emulsion polymer is composed of a mixture of water, amine salt of modified acrylic copolymer, zinc ammonium carbonate, unreacted ammonium hydroxide, and polypropylene glycol in the range of about 38-46% by weight of said composition;
said water is in the range of about 9.5-13% by weight of said composition;
said mineral oil defoamer is composed of a mixture of paraffin-based mineral oils and hydrophobic components containing silicone of about 0.23% by weight of said composition;
said finely micronized polypropylene wax is composed of a polypropylene hydrocarbon mixture in the range of about 4.5-5.5% by weight of said composition; and
said acrylic emulsion binder is composed of a mixture of ammonia salt of modified styrene acrylic polymers, water, and unreacted ammonium hydroxide in the range of about 38-46% by weight of said composition.

3. The composition according to claim 1, wherein:
said acrylic emulsion polymer is composed of a mixture of water, amine salt of modified acrylic copolymer, zinc ammonium carbonate, unreacted ammonium hydroxide, and polypropylene glycol of about 42% by weight of said composition;
said water is about 10.5% by weight of said composition;
said mineral oil defoamer is composed of a mixture of paraffin-based mineral oils and hydrophobic components containing silicone of about 0.23% by weight of said composition;
said finely micronized polypropylene wax is composed of a polypropylene hydrocarbon mixture of about 5% by weight of said composition; and
said acrylic emulsion binder is composed of a mixture of ammonia salt of modified styrene acrylic polymers, water, and unreacted ammonium hydroxide of about 42% by weight of said composition.

4. The composition according to claim 1, wherein the ratio of said acrylic emulsion polymer and said acrylic emulsion binder is 1:1.

5. A method for preparing a water-based, low volatile organic compound coating composition substantially devoid of carcinogens, comprising the steps of:
mixing an acrylic emulsion polymer with water;
adding a solution of a mineral oil defoamer in water;
adding a finely micronized polypropylene wax; and
adding an acrylic emulsion binder.

6. The method according to claim 5, wherein:
said acrylic emulsion polymer with water is composed of a mixture of water, amine salt of modified acrylic copolymer, zinc ammonium carbonate, unreacted ammonium hydroxide, and polypropylene glycol in the range of about 38-46% by weight of said composition with water in the range of about 9-12.5% by weight of said composition;
said solution of a mineral oil defoamer in water is composed of a mixture of paraffin-based mineral oils and hydrophobic components containing silicone of about 0.23% by weight of said composition and water of about 0.50% by weight of said composition;
said finely micronized polypropylene wax is composed of a polypropylene hydrocarbon mixture in the range of about 4.5-5.5% by weight of said composition; and
said acrylic emulsion binder is composed of a mixture of ammonia salt of modified styrene acrylic polymers, water, and unreacted ammonium hydroxide in the range of about 38-46% by weight of said composition.

7. The method according to claim 5, wherein:
said acrylic emulsion polymer with water is composed of a mixture of water, amine salt of modified acrylic copolymer, zinc ammonium carbonate, unreacted ammonium hydroxide, and polypropylene glycol in the range of about 42% by weight of said composition with water in the range of about 10% by weight of said composition;
said solution of a mineral oil defoamer in water is composed of a mixture of paraffin-based mineral oils and hydrophobic components containing silicone of about 0.23% by weight of said composition and water of about 0.50% by weight of said composition;
said finely micronized polypropylene wax is composed of a polypropylene hydrocarbon mixture in the range of about 5% by weight of said composition; and
said acrylic emulsion binder is composed of a mixture of ammonia salt of modified styrene acrylic polymers, water, and unreacted ammonium hydroxide in the range of about 42% by weight of said composition.

8. The method according to claim 5, wherein the ratio of said acrylic emulsion polymer and said acrylic emulsion binder is 1:1.

9. A method for preparing a document having concealed indicia and a primer coating that is a water-based, low volatile organic compound coating composition substantially devoid of carcinogens, comprising the steps of:
providing a base layer of said document;
adhering a foil layer to said base layer;
providing said water-based, low volatile organic compound coating composition substantially devoid of carcinogens including an acrylic emulsion polymer, water, a mineral oil defoamer, a finely micronized polypropylene wax, and an acrylic emulsion binder;
applying said coating composition onto said foil layer;
allowing said composition to dry;
printing said indicia on said document;
applying a release coating to said document over said indicia; and
applying an opaque coating to said document over said release coating to conceal said indicia.

10. The method according to claim 9, wherein:
said acrylic emulsion polymer is composed of a mixture of water, amine salt of modified acrylic copolymer, zinc ammonium carbonate, unreacted ammonium hydroxide, and polypropylene glycol in the range of about 38-46% by weight of said composition;
said water is in the range of about 9.5-13% by weight of said composition;
said mineral oil defoamer is composed of a mixture of paraffin-based mineral oils and hydrophobic components containing silicone of about 0.23% by weight of said composition;
said finely micronized polypropylene wax is composed of a polypropylene hydrocarbon mixture in the range of about 4.5-5.5% by weight of said composition; and
said acrylic emulsion binder is composed of a mixture of ammonia salt of modified styrene acrylic polymers, water, and unreacted ammonium hydroxide in the range of about 38-46% by weight of said composition.

11. The method according to claim 9, wherein:
said acrylic emulsion polymer is composed of a mixture of water, amine salt of modified acrylic copolymer, zinc ammonium carbonate, unreacted ammonium hydroxide, and polypropylene glycol of about 42% by weight of said composition;
said water is about 10.5% by weight of said composition;
said mineral oil defoamer is composed of a mixture of paraffin-based mineral oils and hydrophobic components containing silicone of about 0.23% by weight of said composition;
said finely micronized polypropylene wax is composed of a polypropylene hydrocarbon mixture of about 5% by weight of said composition; and
said acrylic emulsion binder is composed of a mixture of ammonia salt of modified styrene acrylic polymers, water, and unreacted ammonium hydroxide of about 42% by weight of said composition.

12. The method according to claim 9, wherein the ratio of said acrylic emulsion polymer and said acrylic emulsion binder is 1:1.

13. The method according to claim 9, wherein said coating composition is applied to said document by means of gravure printing.

14. The method according to claim 9, wherein said coating composition is dried by an oven heated to 250-400° F.

15. The method according to claim 9, wherein said coating composition is dried by two ovens heated to 250° F.

16. A water-based, low volatile organic compound coating composition substantially devoid of carcinogens, comprising:
an acrylic emulsion polymer;
water;
a mineral oil defoamer;
a finely micronized polypropylene wax;
an acrylic emulsion binder; and
wherein said coating composition is composed of about 0.625% volatile organic compounds and exhibits a minimum dyne level of 38.

17. The composition according to claim 16, wherein:
said acrylic emulsion polymer is composed of a mixture of water, amine salt of modified acrylic copolymer, zinc ammonium carbonate, unreacted ammonium hydroxide, and polypropylene glycol in the range of about 38-46% by weight of said composition;
said water is in the range of about 9.5-13% by weight of said composition;
said mineral oil defoamer is composed of a mixture of paraffin-based mineral oils and hydrophobic components containing silicone of about 0.23% by weight of said composition;
said finely micronized polypropylene wax is composed of a polypropylene hydrocarbon mixture in the range of about 4.5-5.5% by weight of said composition; and
said acrylic emulsion binder is composed of a mixture of ammonia salt of modified styrene acrylic polymers, water, and unreacted ammonium hydroxide in the range of about 38-46% by weight of said composition.

18. The composition according to claim 16, wherein:
said acrylic emulsion polymer is composed of a mixture of water, amine salt of modified acrylic copolymer, zinc ammonium carbonate, unreacted ammonium hydroxide, and polypropylene glycol of about 42% by weight of said composition;
said water is about 10.5% by weight of said composition;
said mineral oil defoamer is composed of a mixture of paraffin-based mineral oils and hydrophobic components containing silicone of about 0.23% by weight of said composition;
said finely micronized polypropylene wax is composed of a polypropylene hydrocarbon mixture of about 5% by weight of said composition; and
said acrylic emulsion binder is composed of a mixture of ammonia salt of modified styrene acrylic polymers, water, and unreacted ammonium hydroxide of about 42% by weight of said composition.

19. The composition according to claim 16, wherein the ratio of said acrylic emulsion polymer and said acrylic emulsion binder is 1:1.
